(19) United States
(12) Patent Application Publication
(10) Pub. No.: US 2026/0277289 A1
(43) Pub. Date: Sep. 17, 2026

(54) PROCESSOR CLUSTER ENERGY MANAGEMENT CIRCUITS AND METHODS OF MANAGING ENERGY OF A PROCESSOR CLUSTER

(71) Applicant: QUALCOMM Incorporated, San Diego, CA (US)

(72) Inventors: Sagar Koorapati, Longview, TX (US); Daniel Ryan Rhodes, Castle Rock, CO (US); Nitin Makhija, San Jose, CA (US)

(21) Appl. No.: 19/078,668

(22) Filed: Mar. 13, 2025

(51) Int. Cl. G06F 1/28; G06Q 30/018

(52) U.S. Cl. CPC G06F 1/28; G06Q 30/018

(57) ABSTRACT

In contrast to integrated circuits (ICs) having uniform clusters of homogeneous processor cores, the task of dividing a total IC power budget is more complicated in ICs having heterogeneous clusters and processing circuits with various activity levels. In a processor cluster including a plurality of processing circuits, which includes at least a first type processing circuit and at least a second type processing circuit, a cluster power management circuit receives a cluster energy credit and generates processor energy credits for the plurality of processing circuits. The processor energy credits for each of the processing circuits are based on a weight corresponding to the processing circuit applied to the cluster energy credits, and on signals configured to suspend provision of the processor energy credits to the processing circuit. Weights for the processing circuits may be stored in programmable storage circuits. Suspended energy credits of a processing circuit may be reallocated.

### TECHNICAL FIELD

The technology of the disclosure relates generally to power management in an integrated circuit (IC), and more particularly to allocating a power budget to processing circuits in a processor cluster.

### BACKGROUND

Energy consumption in an integrated circuit (IC) may be controlled to optimize performance. In an IC, such as a system-on-chip (SOC) that includes clusters of processing circuits, a chip level energy management circuit may be used to distribute power to the respective clusters based on a total power budget. The power allocated to a processor cluster may be adjusted based on processing circuits within the processor cluster. An amount of power allocated to a processor cluster may be evenly divided according to a number of circuits of a same type. Software can track the execution of instructions in the processing circuits and adjust the allocation of power based on activity levels in the processing circuits, but the delays between when the software receives notice of a need for an adjustment of the power allocation and a response that changes the allocated power may be too long to avoid poor performance or even physical damage to the IC.

### SUMMARY

Aspects disclosed in the detailed description include processor cluster energy management circuits. Related methods of managing energy of a processor cluster are also disclosed. Integrated circuits (ICs) having multiple processor clusters may allocate energy credits to each processor cluster based on a portion of a total power budget with an objective of maximizing performance of the processors in each processor cluster and avoiding effects of excessive processing activity, such as high temperatures, voltage droops, and current surges. In contrast to ICs having uniform clusters of homogeneous processor cores with similar activity levels, the task of dividing a total IC power budget is more complicated in ICs having heterogeneous clusters and processing circuits with various activity levels.

In an exemplary processor cluster including a plurality of processing circuits, which includes at least a first type processing circuit and at least a second type processing circuit, a cluster power management circuit receives a cluster energy credit and generates processor energy credits for the plurality of processing circuits. The processor energy credits for each of the processing circuits are based on a weight corresponding to the processing circuit applied to the cluster energy credits, and on signals configured to suspend provision of the processor energy credits to the processing circuit. In some examples, the weights for the processing circuits may be stored in programmable storage circuits. In some examples, suspended energy credits of a processing circuit may be reallocated.

In this regard, in one aspect, a processor cluster is disclosed. The processor cluster includes a plurality of processing circuits, comprising at least one first type processing circuit; and at least one second type processing circuit. The processor cluster also includes a cluster energy management circuit configured to receive first cluster energy credits; and generate first processor energy credits for the plurality of processing circuits. The first processor energy credits generated for each processing circuit of the plurality of processing circuits is based on a weight corresponding to the processing circuit and applied to the first cluster energy credits; and a plurality of signals configured to suspend providing the first processor energy credits to a first processing circuit of the plurality of processing circuits.

In another aspect, a method in processor cluster energy management circuits and managing energy in a processor cluster is disclosed. The method includes receiving first cluster energy credits in a cluster energy management circuit; and generating first processor energy credits for a plurality of processing circuits. The plurality of processing circuits comprises at least one first type processing circuit and at least one second type processing circuit; and the first processor energy credits for each processing circuit of the plurality of processing circuits is based on a weight corresponding to the processing circuit and applied to the first cluster energy credits; and a plurality of signals configured to suspend providing the first processor energy credits to a first processing circuit of the plurality of processing circuits.

In another aspect, an IC is disclosed. The IC includes a chip energy management circuit configured to generate first cluster energy credits; and a first processor cluster. The first processor cluster comprising a plurality of processing circuits, comprising at least one first type processing circuit; and at least one second type processing circuit. The first processor cluster also comprises a cluster energy management circuit configured to receive the first cluster energy credits; and generate first processor energy credits for the plurality of processing circuits. The first processor energy credits generated for each processing circuit of the plurality of processing circuits is based on a weight corresponding to the processing circuit and applied to the first cluster energy credits; and a plurality of signals configured to suspend providing the first processor energy credits to a processing circuit of the plurality of processing circuits.

### BRIEF DESCRIPTION OF THE DRAWINGS

FIG. 1 is a schematic diagram of an integrated circuit (IC) in which a cluster energy management circuit in a processor cluster generates processor energy credits for a plurality of processing circuits based on a cluster energy credit;

FIG. 2 is a schematic diagram of a cluster energy credit circuit of the cluster energy management circuit in FIG. 1, illustrating one example of a logic circuit for generating cluster energy credits for the processor cluster;

FIG. 3 is a schematic diagram of a credit share circuit in the cluster energy management circuit of FIG. 1, illustrating an example of a logic circuit for generating processor energy credits for processing circuits in the processor cluster based on the cluster energy credits;

FIG. 4 is a flowchart of a method of generating processor energy credits for processing circuits in a processor cluster in an IC based on cluster energy credits;

FIG. 5 is a block diagram of an exemplary wireless communication device that may include the IC of FIG. 1, in which a cluster energy management circuit in a processor cluster generates processor energy credits for a plurality of processing circuits based on cluster energy credits; and

FIG. 6 is a block diagram of an exemplary processor-based system that may be included in an IC in which a cluster energy management circuit in a processor cluster generates processor energy credits for a plurality of processing circuits based on cluster energy credits.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include processor cluster energy management circuits. Related methods of managing energy of a processor cluster are also disclosed. Integrated circuits (ICs) having multiple processor clusters may allocate energy credits to each processor cluster based on a portion of a total power budget with an objective of maximizing performance of the processors in each processor cluster and avoiding effects of excessive processing activity, such as high temperatures, voltage droops, and current surges. In contrast to ICs having uniform clusters of homogeneous processor cores with similar activity levels, the task of dividing a total IC power budget is more complicated in ICs having heterogeneous clusters and processing circuits with various activity levels.

In an exemplary processor cluster including a plurality of processing circuits, which includes at least a first type processing circuit and at least a second type processing circuit, a cluster power management circuit receives a cluster energy credit and generates processor energy credits for the plurality of processing circuits. The processor energy credits for each of the processing circuits are based on a weight corresponding to the processing circuit applied to the cluster energy credits, and on signals configured to suspend provision of the processor energy credits to the processing circuit. In some examples, the weights for the processing circuits may be stored in programmable storage circuits. In some examples, suspended energy credits of a processing circuit may be reallocated.

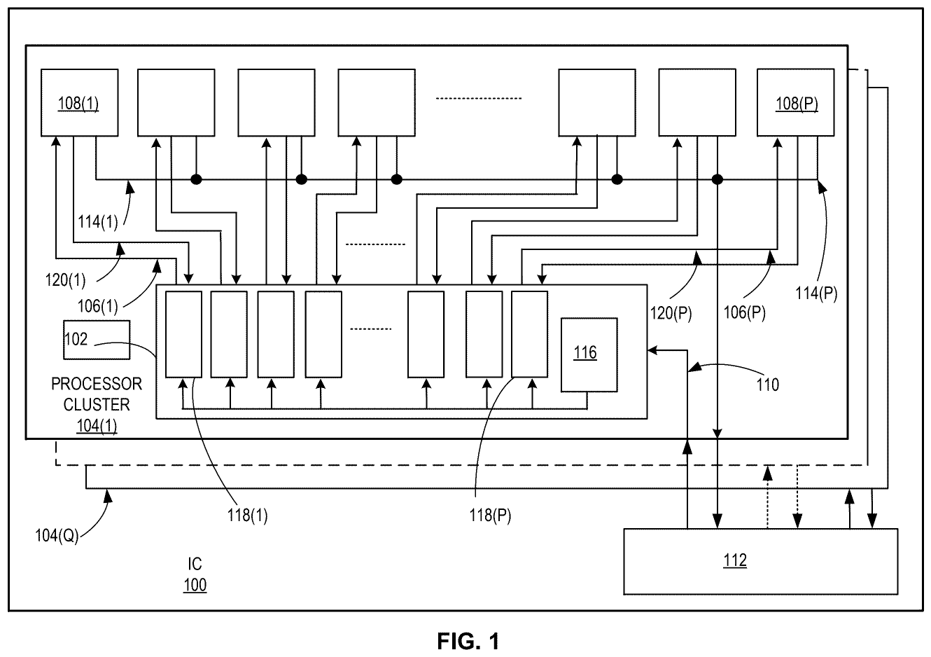

FIG. 1 is a schematic diagram of an integrated circuit (IC) 100 in which a cluster energy management circuit 102 in a processor cluster 104(1) generates processor energy credits 106(1)-106(P) for processing circuits 108(1)-108(P) based on cluster energy credits 110. The IC 100 in the example in FIG. 1 includes multiple processor clusters 104(1)-104(Q) that may each include a plurality of processing circuits and receive unique cluster energy credits 110. The processing circuits 108(1)-108(P) may be homogeneous cores that are of a same processing circuit type and configured to provide a same function, or they may be heterogeneous, wherein there are at least one first type processing circuit and at least one second type processing circuit that are configured to provide different types of processing functions. The processing circuits may be compute engines of multiple types, accelerators, cache subsystems, etc. that execute software instructions or perform functions such as data processing based on control signals. Some of the processing circuits 108(1)-108(P) may execute instructions under software control, may be entirely hardware circuits that process received data, or may be under a combination of hardware and software control. In each of the processing circuits 108(1)-108(P), energy is consumed by circuit activity (e.g., switching, charging, discharging, etc. of transistor circuits and analog circuits). Thus, in this regard, the processing circuits 108(1)-108(P) may be described as energy consuming entities.

Power may be defined as a rate at which energy is provided to or consumed by an energy consuming entity. The power provided to the processing circuits in the respective processor clusters 104(1)-104(Q) may have a variety of effects in the IC 100, including generating heat, causing voltage droops on power rails, and/or causing sudden current changes. Heat generation can raise local temperatures first and ultimately increase temperatures across the entire IC 100 which, left unchecked, can cause performance losses and even permanent damage to the IC 100. Voltage droops and current surges can have enough impact on circuit operation to cause errors in the functions of digital logic circuits and may also cause permanent damage to such circuits. These and other power related effects can be monitored to determine whether/when a threshold is being approached or reached. In an effort to prevent any power-related effects from exceeding such thresholds, the rates of energy consumption in the processor clusters 104(1)-104(Q) and any other circuits across the IC 100 may be controlled.

The IC 100 includes a chip energy management circuit 112 to monitor and manage energy consumption of the respective processor clusters 104(1)-104(Q) and other logic circuits. A function of the chip energy management circuit 112 is to provide each processor cluster 104(1)-104(Q) as much energy as it is expected to need for optimal performance within the limitations of a total chip energy budget. To provide a balanced distribution of energy in the IC 100 and efficiently control energy consumption in the processor cluster 104(1), the chip energy management circuit 112 may obtain information from each of the processing circuits 108(1)-108(P). In particular, the chip energy management circuit 112 may receive energy consumption indications 114(1)-114(P) from the processing circuits 108(1)-108(P) in the processor cluster 104(1) and provide the cluster energy credits 110 to the cluster energy management circuit 102.

The energy consumption indications 114(1)-114(P) may be based on activity that has occurred, is occurring, and/or is expected to occur in an upcoming window of time in the processing circuits 108(1)-108(P). The chip energy management circuit 112 generates the cluster energy credits 110 for a first, upcoming window or period of time based on energy consumption indications 114(1)-114(P) of the processing circuits 108(1)-108(P) in the processor cluster 104(1) and similar indications from the processing circuits in any of the other processor clusters 104(2)-104(Q) as well as indications from other circuits on the IC 100 and recent and/or present states of the power-related effects discussed above. The cluster energy credits 110 may be determined as a portion, fraction, or percentage of a total chip energy budget. Thus, the cluster energy credits 110 provided to the processor cluster 104(1) may include a first integer number of energy credits and a first fraction of an energy credit. An energy credit in this context corresponds to an amount of energy that may be consumed, and the cluster energy credits 110 for the processor cluster 104(1) indicate an amount of energy that may be consumed in a period of time. The amount of energy represented by an energy credit may be programmable. In addition, the cluster energy credits 110 may be received in the processor cluster 104(1) periodically for periods that may be programmable in length.

For example, a period for which cluster energy credits 110 are generated may be programmed as a number (e.g., 32) of cycles of a system clock signal (not shown), for example. In a second period, the processor cluster 104(1) may receive second cluster energy credits 110 comprising another integer number of energy credits and another fractional number of an energy credit. The cluster energy credits 110 may indicate a limit of an amount of energy that may be consumed in the processor cluster 104(1) in the second period. In this regard, each period may also be referred to as a “budget period” for which an amount of energy (e.g., an energy budget) may be determined for cluster and processing circuits.

The processor energy credits 106(1)-106(P) are generated based on the cluster energy credits 110 and provided to processing circuits 108(1)-108(P). The processing circuits 108(1)-108(P) may be configured to control activity in a first period according to the processor energy credits 106(1)-106(P) in the first period and adjust activity in a second period based on the processor energy credits 106(1)-106(P) in the second period.

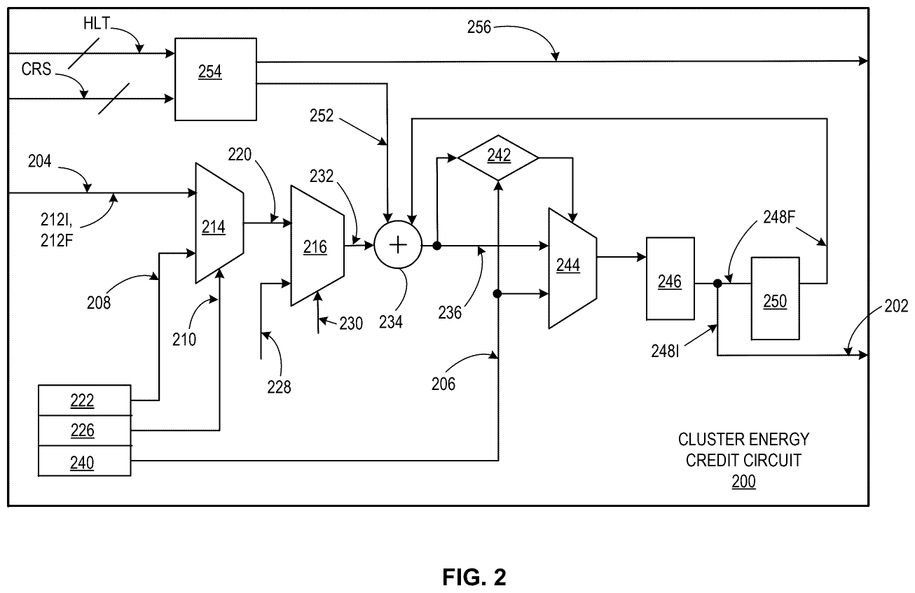

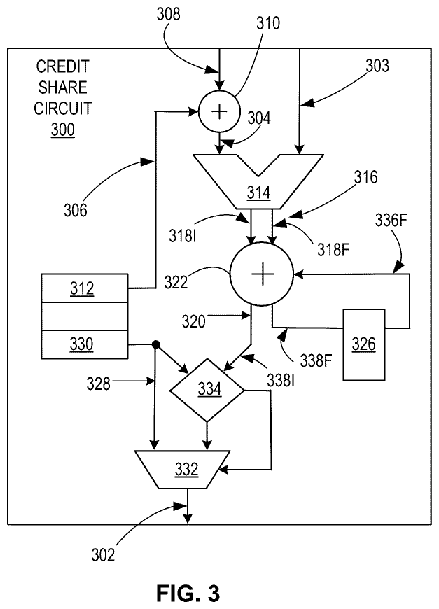

Each of the cluster energy credits 110 provided to the processor cluster 104(1) permits the processor cluster 104(1) to consume a corresponding amount of energy in a period. The cluster energy management circuit 102 receives the first cluster energy credits 110 (e.g., in a first period) and generates processor energy credits 106(1)-106(P) to the processing circuits 108(1)-108(P) based on the cluster energy credits 110 and weights (not shown here, see FIGS. 2 and 3) associated with each of the processing circuits 108(1)-108(P). The cluster energy management circuit 102 provides the processor energy credits 106(1)-106(P) to the processing circuits 108(1)-108(P) to control (e.g., throttle, decrease or increase) activity in the processing circuits 108(1)-108(P).

As noted above, the processing circuits 108(1)-108(P) may be homogeneous in their processing circuit type, having identical or substantially identical circuits and configured to perform a same set of one or more functions. Alternatively, the processing circuits 108(1)-108(P) may each be of different types. In some examples, there may be at least one of a first type processing circuit and at least one of a second type processing circuit, wherein the first types and the second may be configured to provide a same type of processing function or different types of processing functions from each other. In addition, processing circuits of a same type (e.g., same hardware circuits) may be programmed to operate differently. For the above reasons, the power consumption expectations of each of the processing circuits 108(1)-108(P) may be unique. Additionally, functions or operations of the processing circuits 108(1)-108(P) may have different priorities.

Accordingly, each of the processing circuits 108(1)-108(P) may be associated with a unique weight, which may be programmable. The weights may be set by firmware when the IC 100 is powered on. The weights may be initially determined by testing. In some examples the weights may be modified dynamically in response to feedback regarding the power-related effects to the IC 100 while executing certain applications. The weights may be designated by a hardware circuit and may be unchangeable in some examples. In some examples, as explained further below, the cluster energy management circuit 102 may modify the weights associated with some of the processing circuits 108(1)-108(P) based on signals indicating inactivity or a low level of activity in at least one of the processing circuits 108(1)-108(P). The cluster energy management circuit 102 generates the processor energy credits 106(1)-106(P) for each of the processing circuits 108(1)-108(P) based on a weight corresponding to the processing circuit applied to the first cluster energy credits 110. In some examples, applying the weight to the first cluster energy credits 110 may include multiplying the weight for a processing circuit by the first cluster energy credits 110. Other algorithms for applying the weights may be used.

The cluster energy management circuit 102 includes a cluster energy credit circuit 116 and a plurality of credit share circuits 118(1)-118(P), such that there is one of the credit share circuits 118(1)-118(P) for each of the processing circuits 108(1)-108(P). In some examples, one of the credit share circuits 118(1)-118(P) may be associated with two or more of the processing circuits 108(1)-108(P) in the processor cluster 104(1). As discussed with reference to FIG. 2, the cluster energy management circuit 102 also generates the processor energy credits 106(1)-106(P) for each of the processing circuits 108(1)-108(P) based on signals 120(1)-120(P) configured to suspend providing the processor energy credits 106(1)-106(P) to one or more of the processing circuits 108(1)-108(P).

FIG. 2 is a schematic diagram of a cluster energy credit circuit 200, which may be the cluster energy credit circuit 116 of the cluster energy management circuit 102 in FIG. 1. FIG. 2 illustrates one example of a logic circuit for generating adjusted cluster energy credits 202 for one of the processing circuits 108(1)-108(P) in FIG. 1. In each budget period, the cluster energy credit circuit 200 may receive cluster energy credits 204, which may be the cluster energy credits 110 in FIG. 1, and generate the adjusted cluster energy credits 202 based on the cluster energy credits 204. As explained below, in some budget periods, the adjusted cluster energy credits 202 may be the same as the cluster energy credits 204 provided in the same budget period. In some examples, the adjusted cluster energy credits 202 may be greater than or less than the cluster energy credits 204. In some examples, the adjusted cluster energy credits 202 may be based on a cluster threshold energy credit 206 in response to the cluster energy credits 204 exceeding the cluster threshold energy credit 206. In some examples, the adjusted cluster energy credits 202 may be based on a programmed energy credit 208 in response to an override signal 210.

Processing of the cluster energy credits 204 is explained with reference to FIG. 2. The cluster energy credit circuit 200 receives the cluster energy credits 204, which may be a binary value that indicates an integer number of energy credits 212I and a fraction 212F (also referred to as “fractional number 212F”) of an energy credit. The fraction 212F of an energy credit may also be referred to as a decimal portion or percentage of an energy credit and indicates a quantity of less than one (1) energy credit.

The cluster energy credit circuit 200 includes a first multiplexer 214 and a second multiplexer 216. The first multiplexer 214 may be configured to select either the cluster energy credits 204 or a programmed energy credit 208 as a first selected credit 220 to be provided to the second multiplexer 216. The programmed energy credit 208 may be stored in a first configuration register 222. The first multiplexer 214 selects between the cluster energy credits 204 and the programmed energy credit 208 based on the override signal 210, which may be stored in a second configuration register 226. The programmed energy credit 208 may be used for testing, debugging, or predetermined processing situations, for example.

The second multiplexer 216 receives the first selected credit 220 and is configured to pass, in response to a reset signal 230, either the first selected credit 220 or a reset value (e.g., zero) 228 as a second selected credit 232. The second selected credit 232 is provided to an adder circuit 234, which is configured to generate a credit sum 236. The credit sum 236 may be compared to a cluster threshold energy credit 206, which is stored in a third configuration register 240. The cluster threshold energy credit 206 may be a maximum energy credit that is safe to use to avoid known problems. The cluster energy credit circuit 200 includes a comparator 242 that receives the cluster threshold energy credit 206 and the credit sum 236 and controls a third multiplexer 244 to select one of the cluster threshold energy credit 206 and the credit sum 236 as the adjusted cluster energy credits 202. The adjusted cluster energy credits 202 may be a binary value that may be stored in a first register 246. Like the cluster energy credits 204, the adjusted cluster energy credits 202 includes an integer number 248I of energy credits, and a fractional number 248F of an energy credit. The integer number 248I, which indicates a number of whole energy credits, is provided as the adjusted cluster energy credits 202 to a credit share circuit 300 as shown in FIG. 3, which may be any of the credit share circuits 118(1)-118(P) in FIG. 1.

With continued reference to FIG. 2 and FIG. 1, the fractional number 248F of an energy credit in the adjusted cluster energy credits 202 may be stored in a second register 250, which is coupled back to the adder circuit 234. The fractional number 248F from one budget period may be preserved and added to second adjusted cluster energy credits 202 in a next period. The fractional number 248F may be preserved to avoid a loss of energy credits allocated to the processor cluster 104(1) of FIG. 1 in the cluster energy credits 204. A loss of the fraction 248F of an energy credit in each period may cause a reduction of performance and provide no benefit. The credit sum 236 in a second budget period is a total of the fractional number 248F of an energy credit stored in the second register 250 in a first budget period and the adjusted cluster energy credits 202 of a second budget period (selected as the second selected credit 232).

The credit sum 236 may be a sum of the second selected credit 232 and a shared weight credit 252. The shared weight credit 252 may be used to recover unused credits previously provided (e.g., in a previous budget period) to one of the processing circuits 108(1)-108(P). A credit recovery circuit 254 may receive a halt signal HLT or a credit-stop signal CRS from at least one of the processing circuits 108(1)-108(P). The halt signal HLT and/or the credit-stop signal CRS may be the signals 120(1)-120(P) from the processing circuits 108(1)-108(P). A processing circuit may activate the halt signal HLT to indicate that the processing circuit is inactive or expects to be inactive, which may indicate a low-power state, a clock-gating state, or merely a lack of instructions or data to process. The halt signal HLT may indicate that the processing circuit is currently inactive or has sufficient energy credits to perform all the expected activity expected in a period and expects remain inactive for the upcoming period.

In contrast, the processing circuit may activate the credit-stop signal CRS to indicate that the processing circuit has no need for additional energy credits for a different reason. For example, a processing circuit may activate the credit-stop signal CRS when the processing circuit is active but may be temporarily suspending normal activity. One example of temporarily suspending normal activity may be waiting for data to be accessed from a memory or cache, which may take dozens or hundreds of cycles of the system clock. In another example, a processing circuit may activate the credit-stop signal CRS when the processing circuit is active but has accumulated more energy credits than needed. Here, the processing circuit may have accumulated more energy credits than it expects to consume in the budget period. In such circumstances, some of the energy credits provided to the processing circuit(s) may be allocated to other processing circuits, so the processing circuit activates the credit-stop signal CRS. Thus, the processing circuit activates one of the halt signal HLT or the credit-stop signal CRS to request suspension of one of the processor energy credits 106(1)-106(P). In response to receiving one of the halt signal HLT and the credit-stop signal CRS from one of the processing circuits 108(1)-108(P), the cluster energy credit circuit 200 may suspend the processor energy credits to the processing circuit, as described below.

The shared weight credit 252 is an indication of unused energy credits from at least one processing circuit that has activated either the halt signal HLT or the credit-stop signal CRS. The shared weight credit 252 may include signals from multiple processing circuits. The credit recovery circuit 254 may generate a weight adjustment 256 based on the halt signal HLT and the credit-stop signal CRS from each of the processing circuits. The weight adjustment 256 accumulates the weights of the processing circuits that have activated either the halt signal HLT or the credit-stop signal CRS so that their energy credits may be divided or otherwise reallocated and forwarded to the credit share circuits 118(1)-118(P) in FIG. 1.

FIG. 3 is a schematic diagram of a credit share circuit 300 in the cluster energy management circuit 102 of FIG. 1, illustrating an example of a logic circuit for generating a processor energy credit 302, which may be one of the processor energy credits 106(1)-106(P) for the processing circuits 108(1)-108(P) in the processor cluster 104(1) in FIG. 1, based on the adjusted cluster energy credits 303. The adjusted cluster energy credits 303 may be the adjusted cluster energy credits 202 generated in the cluster energy credit circuit 200 in FIG. 2. Related features of FIG. 1 and FIG. 2 may also be referenced in the following description.

The adjusted cluster energy credits 303 indicates a total number of energy credits available to be allocated among the processing circuits 108(1)-108(P) in the processor cluster 104(1) that have not activated either the halt signal HLT or the credit-stop signal CRS. These processing circuits may be subsequently referred to herein as active processing circuits 108(1)-108(P). Division of the adjusted cluster energy credits 303 may be accomplished by applying a total weight 304 to the adjusted cluster energy credits 303. The total weight 304 may be one of the weights associated with the processing circuits 108(1)-108(P). In some examples, applying the total weight 304 to the adjusted cluster energy credits 303 may include multiplying the adjusted cluster energy credits 303 by the total weight 304, respectively.

For example, in the credit share circuits 300 associated with each of the processing circuits 108(1)-108(P), the adjusted cluster energy credits 303 may be multiplied by the total weight 304 associated with the processing circuit. The total weight 304 may be a sum of a weight 306 associated with the processing circuit and a weight adjustment 308, which may be the weight adjustment 256 in FIG. 2. The weight 306 for each of the processing circuits 108(1)-108(P) may be received from a configuration register 312, which may be a programmable storage circuit. The weight 306 may be programmed to a value according to characteristics of a corresponding processing circuit, such as a rate of power consumption of the processing circuit based on a total number of active circuits or a type of circuits included in the processing circuit. The weight 306 may additionally or alternatively be based on a priority of the processing circuit. Thus, the weights 306 of different processing circuits 108(1)-108(P) may be the same or different whether they are of a same type processing circuit or different types of processing circuits. The total weight 304 may be generated in an adder circuit 310.

In an example in which all of the processing circuits 108(1)-108(P) are active processing circuits 108(1)-108(P), the adjusted cluster energy credits 303 in each corresponding credit share circuit 300 may be multiplied by the weight 306 of the corresponding one of the processing circuits 108(1)-108(P). In examples in which at least one of the processing circuits 108(1)-108(P) has activated one of the halt signal HLT and the credit-stop signal CRS, the adjusted cluster energy credits 202 in FIG. 2 may be multiplied by the total weight 304.

The cluster energy credit circuit 200 in FIG. 2 receives indications of the states of the halt signals HLT and the credit-stop signals CRS from each of the processing circuits 108(1)-108(P) and generates the weight adjustment 308 (weight adjustment 256 in FIG. 2) to each of the credit share circuits 300. In the processing circuits that activated the halt signal HLT or the credit-stop signal CRS, the credit share circuit 300 may be configured to change (reduce) the weights associated with those processing circuits from the weight 306 to zero (0), so that, effectively, no credits are provided to the processing circuits that are in an inactive state or a state of low level activity. In some examples, the cluster energy credit circuit 200 may suspend or not provide the processor energy credits 106(1)-106(P) to one of the processing circuits 108(1)-108(P) that generated either the halt signal HLT or the credit-stop signal CRS. In some examples, the cluster energy credit circuit 200 may provide the processor energy credits 106(1)-106(P) having a value of zero to the one of the processing circuits 108(1)-108(P) that generated either the halt signal HLT or the credit-stop signal CRS. In response to an active halt signal HLT or an active credit-stop signal CRS from at least one processing circuit of the plurality of processing circuits 108(1)-108(P), the cluster energy credit circuit 200 is configured to change (increase) the weight associated with each of the active processing circuits 108(1)-108(P) to redistribute or reallocate the processor energy credits, suspended from the at least one processing circuit that are inactive, to one or more other (active) processing circuits. Thus, a portion of the adjusted cluster energy credits 202 that would have been designated for the processing circuit(s) 108(1)-108(P) that activated the halt signal HLT or the credit-stop signal CRS is reallocated and shared among the active processing circuits 108(1)-108(P). In this manner, in response to the halt signal HLT or the credit-stop signal CRS being activated in one or more of the processing circuits 108(1)-108(P), the cluster energy management circuit 102 is able to reallocate the processor energy credits 106(1)-106(P) suspended from the processing circuits 108(1)-108(P) according to a selected algorithm selected from among a plurality of algorithms. Such algorithms may include dividing the suspended credits in equal shares among the active processing circuits 108(1)-108(P), dividing shares based on a dynamic or static priority (e.g., ranking) or based on an application being executed. A total of the weights 306 in all of the credit share circuits 118(1)-118(P) may be less than or equal to 1.0 to prevent a distribution of more energy credits among the processing circuits 108(1)-108(P) than are allocated to the processor cluster 104(1). The total of the weights 306 in all of the credit share circuits 118(1)-118(P) is preferably very close to 1.0 to avoid wasting any cluster energy credits 110 allocated to the processor cluster 104(1).

The adjusted cluster energy credits 303 are multiplied by the total weight 304 in a multiplier circuit 314. The multiplier circuit 314 may be implemented in any appropriate manner, such as using shift and add circuitry that operates to multiply binary values. Since the total weight 304 may have a value less than 1.0 (e.g., non-integer), the multiplier circuit 314 generates a processor energy credit 316 as a product including an integer number of energy credits 318I and a fractional number 318F.

The integer number of energy credits 318I and the fractional number 318F are provided to an adder circuit 322. A calculated processor energy credit 320 is generated in the adder circuit 322 as a sum of the integer number of energy credits 318I and the fractional number 318F generated in a current budget period and a fractional number 336F of an energy credit stored in a previous budget period. The calculated processor energy credit 320 includes an integer number 338I of energy credits and a fractional number 338F of an energy credit. The fractional number 338F is stored in a register 326 and provided to the adder circuit 322 as the fractional number 336F of an energy credit in a next budget period. The fractional numbers 318F, 336F, and 338F may each represent a portion of an (e.g., less than a whole) energy credit.

The processor energy credits 106(1)-106(P) described with reference to FIG. 1 are provided as whole numbers (e.g., integers) of energy credits, which reduces a number of bits transferred to each of the processing circuits 108(1)-108(P) and may simplify logic circuits in the processing circuits 108(1)-108(P). Thus, the integer number 338I of the calculated processor energy credit 320 may become the processor energy credit 302. The fractional number 338F stored in the register 326 in a first budget period is the fractional number 336F added to the processor energy credit 316 in a next budget period, which may cause the integer number 338I of energy credits to be greater than the integer number of energy credits 318I. Preserving the fractional number 338F from one budget period to the next period allows the processing circuits 108(1)-108(P) to avoid losing portions of energy credits allocated in the processor energy credits 106(1)-106(P). A loss of portions of energy credits could cause an unnecessary and undesirable reduction of performance.

In some examples, the integer number 338I of energy credits of the calculated processor energy credit 320 may be compared, in a comparator 334, to a processor threshold energy credit 328, which may be stored in configuration register 330. The processor threshold energy credit 328 may be employed to limit energy credits allocated to a processing circuit in situations where one or more of the other processing circuits 108(1)-108(P) have activated the halt signal HLT or the credit-stop signal CRS, for example. In response to the integer number 338I of energy credits exceeding the processor threshold energy credit 328, a multiplexer 332 is controlled to select the processor threshold energy credit 328 to be one of the processor energy credit 302. Otherwise, if the integer number 338I of energy credits is less than or equal to the processor threshold energy credit 328, the comparator 334 provides the integer number 338I of energy credits to the multiplexer 332 and controls the multiplexer 332 to select the integer number 338I of energy credits to be the processor energy credit 302.

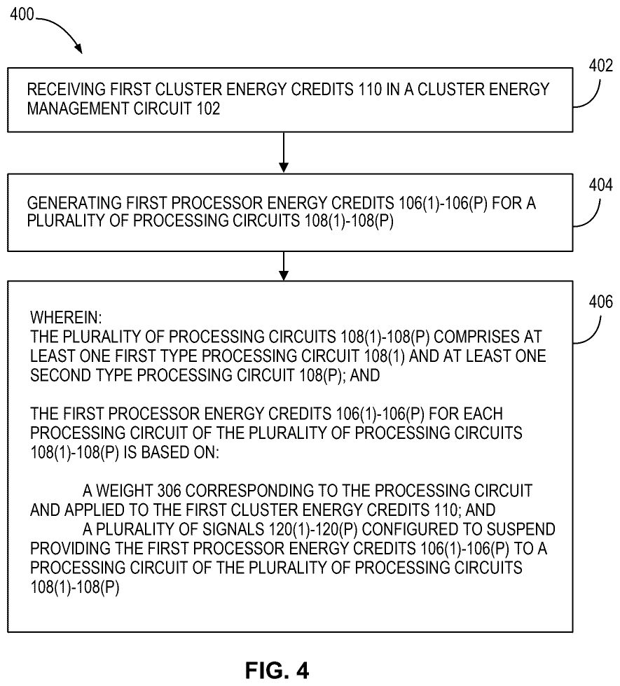

FIG. 4 is a flowchart of a method 400 in a processor cluster 104(1) in FIG. 1. The method includes receiving first cluster energy credits 110 in a cluster energy management circuit 102 (block 402); and generating first processor energy credits 106(1)-106(P) for a plurality of processing circuits 108(1)-108(P) (block 404), wherein: the plurality of processing circuits 108(1)-108(P) comprises at least one first type processing circuit 108(1) and at least one second type processing circuit 108(P); and the first processor energy credits 106(1)-106(P) for each processing circuit of the plurality of processing circuits 108(1)-108(P) is based on: a weight 306 (as shown in FIG. 3) corresponding to the processing circuit and applied to the first cluster energy credits 110; and a plurality of signals 120(1)-120(P) configured to suspend providing the first processor energy credits 106(1)-106(P) to a processing circuit of the plurality of processing circuits 108(1)-108(P) (block 406).

Examples of such processor-based devices, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

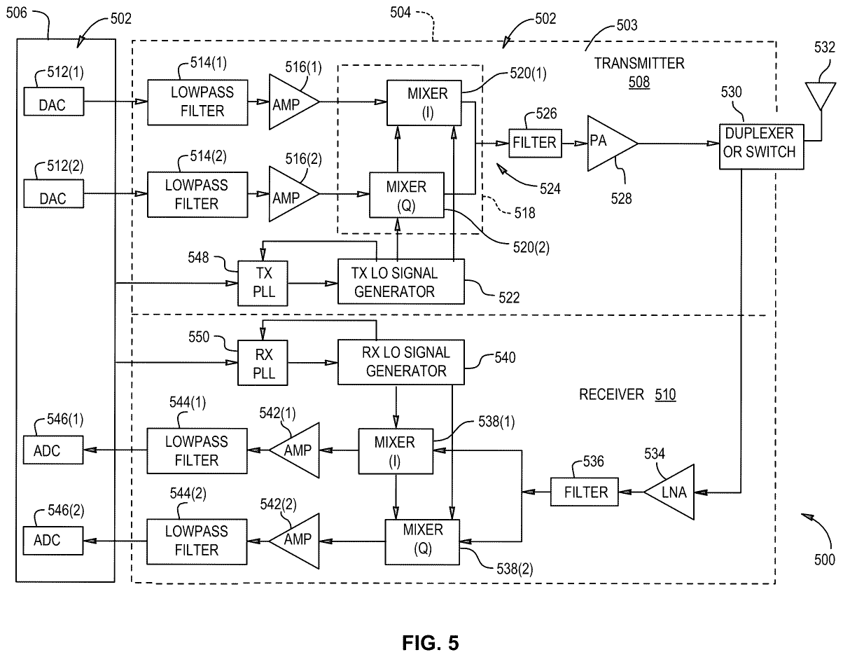

FIG. 5 illustrates an exemplary wireless communications device 500 that includes radio-frequency (RF) components formed from one or more ICs 502, wherein any of the ICs 502 may be included in an IC in which a cluster energy management circuit in a processor cluster generates processor energy credits for a plurality of processing circuits based on a cluster energy budget, as shown in FIGS. 1-3. The wireless communications device 500 may include or be provided in any of the above-referenced devices, as examples. As shown in FIG. 5, the wireless communications device 500 includes a transceiver 504 and a data processor 506. The data processor 506 may include a memory to store data and program codes. The transceiver 504 includes a transmitter 508 and a receiver 510 that support bi-directional communications. In general, the wireless communications device 500 may include any number of transmitters 508 and/or receivers 510 for any number of communication systems and frequency bands. All or a portion of the transceiver 504 may be implemented on one or more analog ICs, RF ICs (RFICs), mixed-signal ICs, etc.

The transmitter 508 or the receiver 510 may be implemented with a super-heterodyne architecture or a direct-conversion architecture. In the super-heterodyne architecture, a signal is frequency-converted between RF and baseband in multiple stages, for example, from RF to an intermediate frequency (IF) in one stage and then from IF to baseband in another stage for the receiver 510. In the direct-conversion architecture, a signal is frequency-converted between RF and baseband in one stage. The super-heterodyne and direct-conversion architectures may use different circuit blocks and/or have different requirements. In the wireless communications device 500 in FIG. 5, the transmitter 508 and the receiver 510 are implemented with the direct-conversion architecture.

In the transmit path, the data processor 506 processes data to be transmitted and provides I and Q analog output signals to the transmitter 508. In the exemplary wireless communications device 500, the data processor 506 includes digital-to-analog converters (DACs) 512(1), 512(2) for converting digital signals generated by the data processor 506 into the I and Q analog output signals (e.g., I and Q output currents) for further processing.

Within the transmitter 508, lowpass filters 514(1), 514(2) filter the I and Q analog output signals, respectively, to remove undesired signals caused by the prior digital-to-analog conversion. Amplifiers (AMPs) 516(1), 516(2) amplify the signals from the lowpass filters 514(1), 514(2), respectively, and provide I and Q baseband signals. An upconverter 518 upconverts the I and Q baseband signals with I and Q transmit (TX) local oscillator (LO) signals through mixers 520(1), 520(2) from a TX LO signal generator 522 to provide an upconverted signal 524. A filter 526 filters the upconverted signal 524 to remove undesired signals caused by the frequency up-conversion as well as noise in a receive frequency band. A power amplifier (PA) 528 amplifies the upconverted signal 524 from the filter 526 to obtain the desired output power level and provides a transmit RF signal. The transmit RF signal is routed through a duplexer or switch 530 and transmitted via an antenna 532.

In the receive path, the antenna 532 receives signals transmitted by base stations and provides a received RF signal, which is routed through the duplexer or switch 530 and provided to a low noise amplifier (LNA) 534. The duplexer or switch 530 is designed to operate with a specific receive (RX)-to-TX duplexer frequency separation, such that RX signals are isolated from TX signals. The received RF signal is amplified by the LNA 534 and filtered by a filter 536 to obtain a desired RF input signal. Down-conversion mixers 538(1), 538(2) mix the output of the filter 536 with I and Q RX LO signals (i.e., LO_I and LO_Q) from an RX LO signal generator 540 to generate I and Q baseband signals. The I and Q baseband signals are amplified by AMPs 542(1), 542(2) and further filtered by lowpass filters 544(1), 544(2) to obtain I and Q analog input signals, which are provided to the data processor 506. In this example, the data processor 506 includes analog-to-digital converters (ADCs) 546(1), 546(2) for converting the analog input signals into digital signals to be further processed by the data processor 506.

In the wireless communications device 500 of FIG. 5, the TX LO signal generator 522 generates the I and Q TX LO signals used for frequency up-conversion, while the RX LO signal generator 540 generates the I and Q RX LO signals used for frequency down-conversion. Each LO signal is a periodic signal with a particular fundamental frequency. A TX phase-locked loop (PLL) circuit 548 receives timing information from the data processor 506 and generates a control signal used to adjust the frequency and/or phase of the TX LO signals from the TX LO signal generator 522. Similarly, an RX PLL circuit 550 receives timing information from the data processor 506 and generates a control signal used to adjust the frequency and/or phase of the RX LO signals from the RX LO signal generator 540.

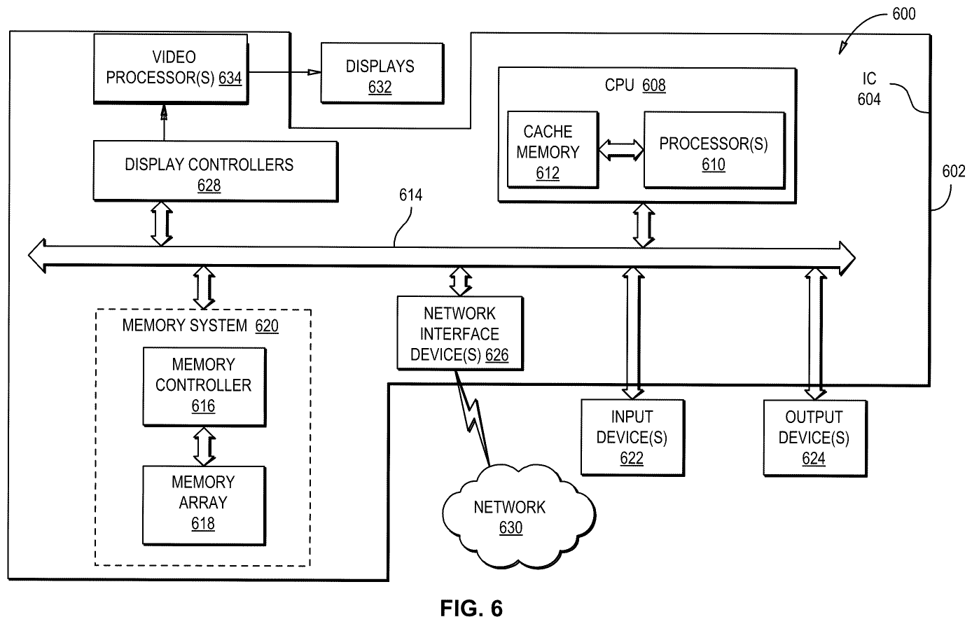

In this regard, FIG. 6 illustrates an example of a processor-based system 600 that can be included in an IC in which a cluster energy management circuit in a processor cluster generates processor energy credits for a plurality of processing circuits based on a cluster energy budget, as shown in FIGS. 1-3. The processor-based system 600 includes a central processing unit (CPU) 608 that includes one or more processors 610, which may also be referred to as CPU cores or processor cores. The CPU 608 may have cache memory 612 coupled to the CPU 608 for rapid access to temporarily stored data. The CPU 608 is coupled to a system bus 614 and can intercouple controlling and controlled devices included in the processor-based system 600. As is well known, the CPU 608 communicates with these other devices by exchanging address, control, and data information over the system bus 614. For example, the CPU 608 can communicate bus transaction requests to a memory controller 616, as an example of a controlled device. Although not illustrated in FIG. 6, multiple system buses 614 could be provided, wherein each system bus 614 constitutes a different fabric.

Other controlling and controlled devices can be connected to the system bus 614. As illustrated in FIG. 6, these devices can include a memory system 620 that includes the memory controller 616 and a memory array(s) 618, one or more input devices 622, one or more output devices 624, one or more network interface devices 626, and one or more display controllers 628, as examples. The input device(s) 622 can include any type of input device, including, but not limited to, input keys, switches, voice processors, etc. The output device(s) 624 can include any type of output device, including, but not limited to, audio, video, other visual indicators, etc. The network interface device(s) 626 can be any device configured to allow an exchange of data to and from a network 630. The network 630 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 626 can be configured to support any type of communications protocol desired.

The CPU 608 may also be configured to access the display controller(s) 628 over the system bus 614 to control information sent to one or more displays 632. The display controller(s) 628 sends information to the display(s) 632 to be displayed via one or more video processor(s) 634, which processes the information to be displayed into a format suitable for the display(s) 632. The display(s) 632 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. The devices and components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It should be understood that the terms “first,” “second,” “third,” etc., where used herein, are relative terms that may be used to distinguish between similarly named elements and are not meant to limit or imply a strict orientation and/or order unless otherwise specified. It should also be understood that that the terms “top,” “upper,” “above,” and “bottom,” “lower,” “below,” where used herein, are relative terms and are not meant to limit or imply a strict orientation. A “top” or “upper” or “above” referenced element does not always need to be oriented to be above a “bottom,” or “lower,” or “below” referenced element with respect to ground, and vice versa. An element referenced as “top,” “upper,” “above,” or “bottom,” “lower,” “below,” may be on top or bottom relative to that example only and the particular illustrated example. An element referenced as “top” or “upper” or “above” “bottom,” “lower,” “below,” another element does not have to be with respect to ground, and vice versa. An element referenced as “top” or “upper” or “above” may be above or below such other referenced element, relative to that example only and the particular illustrated example. For example, if a particular object that is discussed as at “top,” or “upper” or “above” another object, and such particular object is flipped 180 degrees, then such particular object would then be oriented as at “bottom,” or “lower” or “below” such other object.

Further, an object being “adjacent” as discussed herein relates to an object being beside or next to another stated object. Adjacent objects may not be directly physically coupled to each other. An object can be directly adjacent to another object which means that such objects are directly beside or next to the other object without another object or layer being intervening or disposed between the directly adjacent objects. An object can be indirectly or non-directly adjacent to another object which means that such objects are not directly beside or directly next to each other, but there is an intervening object or layer disposed between the non-directly adjacent objects.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Implementation examples are described in the following numbered clauses:

1. A processor cluster, comprising:
a plurality of processing circuits, comprising:
   at least one first type processing circuit; and
   at least one second type processing circuit; and
a cluster energy management circuit configured to: receive first cluster energy credits; and
   generate first processor energy credits for the plurality of processing circuits,
   wherein the first processor energy credits generated for each processing circuit of the plurality of processing circuits is based on:
      a weight corresponding to the processing circuit and applied to the first cluster energy credits; and
      a plurality of signals configured to suspend providing the first processor energy credits to a first processing circuit of the plurality of processing circuits.

2. The processor cluster of clause 1, wherein the cluster energy management circuit is further configured to provide the first processor energy credits to the plurality of processing circuits to control activity in the plurality of processing circuits.

3. The processor cluster of clause 1 or clause 2, wherein the at least one second type processing circuit is configured to provide a different processing function than the at least one first type processing circuit.

4. The processor cluster of any of clause 1 to clause 3, wherein the cluster energy management circuit is further configured to receive the weight for each processing circuit of the plurality of processing circuits from a respective programmable storage circuit.

5. The processor cluster of clause 1 or clause 2, wherein the at least one second type processing circuit is configured to provide a same processing function as the at least one first type processing circuit.

6. The processor cluster of any of clause 1 to clause 5, wherein:
each processing circuit of the plurality of processing circuits is configured to activate a first signal of the plurality of signals to indicate a request for suspension of the first processor energy credits to the processing circuit; and
the cluster energy management circuit is further configured to, in response to the first signal from a first processing circuit of the plurality of processing circuits, suspend the first processor energy credits to the first processing circuit.

7. The processor cluster of clause 6, wherein the cluster energy management circuit is further configured to provide the first processor energy credits having a value of zero to the first processing circuit.

8. The processor cluster of clause 6 or clause 7, wherein the cluster energy management circuit is further configured to, in response to the first signal from the first processing circuit of the plurality of processing circuits, reallocate the first processor energy credits suspended from the first processing circuit to one or more other processing circuits in the plurality of processing circuits.

9. The processor cluster of any of clause 6 to clause 8, wherein the cluster energy management circuit is further configured to, in response to the first signal from the first processing circuit of the plurality of processing circuits, reallocate the first processor energy credits suspended from the first processing circuit according to a selected algorithm selected from among a plurality of algorithms.

10. The processor cluster of any of clause 1 to clause 9, wherein the cluster energy management circuit is further configured to:
in a first period:
   receive the first cluster energy credits comprising a first integer number of energy credits and a first fractional number of an energy credit; and
   generate the first processor energy credits of the plurality of processing circuits based on the first integer number of energy credits; and
in a second period following the first period:
   receive second cluster energy credits comprising a second integer number of energy credits and a second fractional number of an energy credit; and
   generate adjusted second cluster energy credits based on a sum of the first fractional number of an energy credit and the second cluster energy credits.

11. The processor cluster of any of clause 1 to clause 10, wherein the cluster energy management circuit is further configured to:
in a first period:
   generate the first processor energy credits for a first processing circuit of the plurality of processing circuits comprising a third integer number of energy credits and a third fractional number of an energy credit;
   store the third fractional number of an energy credit; and
   provide the third integer number of energy credits to the first processing circuit; and
in a second period following the first period:
   increase the first processor energy credits generated for the first processing circuit by the third fractional number of an energy credit to generate a fourth integer number of energy credits and a fourth fractional number of an energy credit;
   store the fourth fractional number of an energy credit; and
   provide the fourth integer number of energy credits to the first processing circuit.

12. The processor cluster of any of clause 1 to clause 11, wherein the cluster energy management circuit is further configured to:
in response to the first cluster energy credits exceeding a cluster threshold energy credit, generate the first processor energy credits for each processing circuit of the plurality of processing circuits based on the cluster threshold energy credit.

13. The processor cluster of any of clause 1 to clause 12, wherein the cluster energy management circuit is further configured to:
in response to the first processor energy credits for a first processing circuit of the plurality of processing circuits exceeding a processor threshold energy credit, generate the first processor energy credits for the first processing circuit based on the processor threshold energy credit.

14. The processor cluster of any of clause 1 to clause 13, wherein the cluster energy management circuit is further configured to:
in response to an override signal, generate the first processor energy credits for each processing circuit of the plurality of processing circuits based on a programmed energy credit.

15. The processor cluster of any of clause 1 to clause 14, wherein the weight for a first one of the at least one first type processing circuit and a second one of the at least one first type processing circuit are different.

16. The processor cluster of any of clause 1 to clause 15 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics system; a drone; and a multicopter.

17. A method in processor cluster energy management circuits and managing energy in a processor cluster, the method comprising:
receiving first cluster energy credits in a cluster energy management circuit; and
generating first processor energy credits for a plurality of processing circuits,
wherein:
   the plurality of processing circuits comprises at least one first type processing circuit and at least one second type processing circuit; and
   the first processor energy credits for each processing circuit of the plurality of processing circuits is based on:
      a weight corresponding to the processing circuit and applied to the first cluster energy credits; and
      a plurality of signals configured to suspend providing the first processor energy credits to a first processing circuit of the plurality of processing circuits.

18. The method of clause 17, further comprising providing the first processor energy credits to the plurality of processing circuits to control activity in the plurality of processing circuits.

19. The method of clause 17 or clause 18, further comprising suspending the first processor energy credits to the first processing circuit.

20. An integrated circuit (IC), comprising:
a chip energy management circuit configured to generate first cluster energy credits; and
a first processor cluster, comprising:
   a plurality of processing circuits, comprising:
      at least one first type processing circuit; and
      at least one second type processing circuit; and
   a cluster energy management circuit configured to:
      receive the first cluster energy credits; and
      generate first processor energy credits for the plurality of processing circuits,
      wherein the first processor energy credits generated for each processing circuit of the plurality of processing circuits is based on:
         a weight corresponding to the processing circuit and applied to the first cluster energy credits; and
         a plurality of signals configured to suspend providing the first processor energy credits to a processing circuit of the plurality of processing circuits.

What is claimed is:

1. A processor cluster, comprising:
a plurality of processing circuits, comprising:
at least one first type processing circuit; and
at least one second type processing circuit; and
a cluster energy management circuit configured to:
receive first cluster energy credits; and
generate first processor energy credits for the plurality of processing circuits,
wherein the first processor energy credits generated for each processing circuit of the plurality of processing circuits is based on:
a weight corresponding to the processing circuit and applied to the first cluster energy credits; and
a plurality of signals configured to suspend providing the first processor energy credits to a first processing circuit of the plurality of processing circuits.

2. The processor cluster of claim 1, wherein the cluster energy management circuit is further configured to provide the first processor energy credits to the plurality of processing circuits to control activity in the plurality of processing circuits.

3. The processor cluster of claim 1, wherein the at least one second type processing circuit is configured to provide a different processing function than the at least one first type processing circuit.

4. The processor cluster of claim 1, wherein the cluster energy management circuit is further configured to receive the weight for each processing circuit of the plurality of processing circuits from a respective programmable storage circuit.

5. The processor cluster of claim 1, wherein the at least one second type processing circuit is configured to provide a same processing function as the at least one first type processing circuit.

6. The processor cluster of claim 1, wherein:
each processing circuit of the plurality of processing circuits is configured to activate a first signal of the plurality of signals to indicate a request for suspension of the first processor energy credits to the processing circuit; and
the cluster energy management circuit is further configured to, in response to the first signal from a first processing circuit of the plurality of processing circuits, suspend the first processor energy credits to the first processing circuit.

7. The processor cluster of claim 6, wherein the cluster energy management circuit is further configured to provide the first processor energy credits having a value of zero to the first processing circuit.

8. The processor cluster of claim 6, wherein the cluster energy management circuit is further configured to, in response to the first signal from the first processing circuit of the plurality of processing circuits, reallocate the first processor energy credits suspended from the first processing circuit to one or more other processing circuits in the plurality of processing circuits.

9. The processor cluster of claim 6, wherein the cluster energy management circuit is further configured to, in response to the first signal from the first processing circuit of the plurality of processing circuits, reallocate the first processor energy credits suspended from the first processing circuit according to a selected algorithm selected from among a plurality of algorithms.

10. The processor cluster of claim 1, wherein the cluster energy management circuit is further configured to:
in a first period:
receive the first cluster energy credits comprising a first integer number of energy credits and a first fractional number of an energy credit; and
generate the first processor energy credits of the plurality of processing circuits based on the first integer number of energy credits; and
in a second period following the first period:
receive second cluster energy credits comprising a second integer number of energy credits and a second fractional number of an energy credit; and
generate adjusted second cluster energy credits based on a sum of the first fractional number of an energy credit and the second cluster energy credits.

11. The processor cluster of claim 1, wherein the cluster energy management circuit is further configured to:
in a first period:
generate the first processor energy credits for a first processing circuit of the plurality of processing circuits comprising a third integer number of energy credits and a third fractional number of an energy credit;
store the third fractional number of an energy credit; and
provide the third integer number of energy credits to the first processing circuit; and
in a second period following the first period:
increase the first processor energy credits generated for the first processing circuit by the third fractional number of an energy credit to generate a fourth integer number of energy credits and a fourth fractional number of an energy credit;
store the fourth fractional number of an energy credit; and
provide the fourth integer number of energy credits to the first processing circuit.

12. The processor cluster of claim 1, wherein the cluster energy management circuit is further configured to:
in response to the first cluster energy credits exceeding a cluster threshold energy credit, generate the first processor energy credits for each processing circuit of the plurality of processing circuits based on the cluster threshold energy credit.

13. The processor cluster of claim 1, wherein the cluster energy management circuit is further configured to:
in response to the first processor energy credits for a first processing circuit of the plurality of processing circuits exceeding a processor threshold energy credit, generate the first processor energy credits for the first processing circuit based on the processor threshold energy credit.

14. The processor cluster of claim 1, wherein the cluster energy management circuit is further configured to:
in response to an override signal, generate the first processor energy credits for each processing circuit of the plurality of processing circuits based on a programmed energy credit.

15. The processor cluster of claim 1, wherein the weight for a first one of the at least one first type processing circuit and a second one of the at least one first type processing circuit are different.

16. The processor cluster of claim 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics system; a drone; and a multicopter.

17. A method in processor cluster energy management circuits and managing energy in a processor cluster, the method comprising:
receiving first cluster energy credits in a cluster energy management circuit; and
generating first processor energy credits for a plurality of processing circuits,
wherein:
the plurality of processing circuits comprises at least one first type processing circuit and at least one second type processing circuit; and
the first processor energy credits for each processing circuit of the plurality of processing circuits is based on:
a weight corresponding to the processing circuit and applied to the first cluster energy credits; and
a plurality of signals configured to suspend providing the first processor energy credits to a first processing circuit of the plurality of processing circuits.

18. The method of claim 17, further comprising providing the first processor energy credits to the plurality of processing circuits to control activity in the plurality of processing circuits.

19. The method of claim 17, further comprising suspending the first processor energy credits to the first processing circuit.

20. An integrated circuit (IC), comprising:
a chip energy management circuit configured to generate first cluster energy credits; and
a first processor cluster, comprising:
a plurality of processing circuits, comprising:
at least one first type processing circuit; and
at least one second type processing circuit; and
a cluster energy management circuit configured to:
receive the first cluster energy credits; and
generate first processor energy credits for the plurality of processing circuits,
wherein the first processor energy credits generated for each processing circuit of the plurality of processing circuits is based on:
a weight corresponding to the processing circuit and applied to the first cluster energy credits; and
a plurality of signals configured to suspend providing the first processor energy credits to a processing circuit of the plurality of processing circuits.
